(19) United States
(12) Patent Application Publication
(10) Pub. No.: US 2014/0030940 A1
(43) Pub. Date: Jan. 30, 2014

(54) SWIMMER'S TRAINING BUOY WITH VARIABLE BALLAST

(71) Applicant: LAWRENCE JAMES DAY, GRAND BLANC, MI (US)

(72) Inventor: LAWRENCE JAMES DAY, GRAND BLANC, MI (US)

(21) Appl. No.: 13/556,306

(22) Filed: Jul. 24, 2012

(51) Int. Cl. A63B 31/12; G09F 17/00

(52) U.S. Cl. 441/60

(57) ABSTRACT

The invention is a training and teaching aid for swimmers and coaches in the form of a buoy incorporating removable ballasting devices in the form of refillable vessels, or alternatively, weights. The buoy is provided with means for securing the buoy to the body or clothing of the swimmer utilizing the device.

### PRIORITY

The present application claims priority based on U.S. Provisional Patent Application No. 61/511,462, filed Jul. 25, 2011.

### FIELD OF THE INVENTION

The invention relates generally to flotation devices for use by swim coaches for teaching and swimmers in training. More particularly, the invention pertains to flotation device designed to be secured to swimmers' clothing, and provided with ballasting containers for adjusting the amount of flotation afforded by the device.

### DESCRIPTION OF THE PRIOR ART

For competition swimmers, in particular, effective teaching and training can be facilitated by the use of flotation devices for supporting the swimmer's hips and legs so that an appropriately level-position is maintained during training. It is known that improved performance by competitive swimmers can be achieved by training which conditions the swimmer to appropriately position the torso, hips and legs in relation to the surface of the water. To effectively teach the swimmer to recognize appropriate swimming posture, with particular attention to raising the position of the hips and legs in relation to the swimmer's upper body, it is known to utilize flotation devices which are held between the swimmer's legs during training sessions.

One such design is taught by Rademacher in U.S. Pat. No. 4,379,704, which discloses an appropriately formed unitary foam buoy adapted for engagement with and selective retention by the legs of the swimmer. The resiliency of the foam provides the necessary comfort to the swimmer, and the composition of the foam itself provides the necessary flotation. However, this device must be formed of a particular dimension, volume and density to accommodate swimmers of varying weights, body shapes and natural buoyancy. Accordingly, the '704 leg buoy must be manufactured in a variety of different dimensions, to accommodate a large population of swimmers. Further, these buoys can be quickly outgrown by youthful swimmers as they age and develop. Even the same swimmer may benefit from flotation devices which provide variable degrees of buoyancy depending on their stage of training, the strokes being taught and practiced, the anatomy and weight of the swimmer and even the bodies of water in which training is taking place (i.e. salt or fresh water).

A similar device is taught by Hernandez and Lang, U.S. Pat. No. 7,169,000. This device, too, suffers from many of the same limitations of Rademacher. An additional shortcoming of the prior art is the reliance by prior art devices on frictional engagement between the devices and the swimmer's body in order to keep the flotation device in proper position. The lack of securement means on the prior art devices renders them susceptible to becoming dislodged during training, and inconvenience for the swimmer and coach.

There are further limitations in prior art devices. Because swimmers' training is physically demanding, and because swimmers, especially open water swimmers, frequently carry with them personal articles such as identification cards, wallets, spectacles, cell phones and the like, current swimmers' training aids provide no facility for carrying and protecting such personal items, which often must be left poolside, in a locker or changing room, on the beach or in a car where they may be subject to loss or theft. Further, swimmers frequently seek refreshments. Hydration and nutrition in the form of food or drink to be used before, during or after the training session, and current flotation training devices are not equipped with the capability of storing and carrying such items.

Another prior art device, Speedo's “Swimmer's Training Buoy With Variable Ballast,” is a training device comprising a unitary buoy adapted for engagement with a swimmer's legs and having a fillable ballast cavity. However, the swimmer is unable to put personal belongings inside the ballast cavity because of the device's small ballast filling aperture. Further, swimmers are unlikely to fill the ballast with refreshments because the ballast's small filling aperture makes access to the ballast compartment difficult. And lastly, similar to the shortcomings of other prior art devices, the device relies on frictional engagement between the device and the swimmer's body to keep the device in proper position. The lack of securement means the device is susceptible to becoming dislodged during training, and an inconvenience for the swimmer and coach.

In another example of the shortcomings of the prior art, the Kiefer Corporation's Safer Swimming Buoy teaches a device used for swimmers to store personal items while in the water, which comprises a floatable waterproof bag, a strap, and a waist belt for connecting the device to the swimmer. However, the device does not teach the support of the swimmer's legs and hips. Rather, the waterproof bag floats behind the swimmer's legs, and is towed by a swimmer by a strap connected between a waist belt and floatable bag.

Lastly, another limitation of the prior art devices is the lack of a warning element substantially above the surface of the water, which is needed to increase the visibility of the swimmer to watercraft.

### SUMMARY OF THE INVENTION

The present invention overcomes the problems found in the prior art and provides an improved buoy which is readily adjustable for use by different swimmers, and whereby the buoyancy of the device can be adjusted by the user, where a warning device indicates to nearby watercraft that a swimmer is nearby, where the device is capable of carrying refreshments or other materials, and where the device is removably secured to the swimmer to avoid dislodgment during use.

In the preferred embodiment, the buoy is formed with a foam member adapted for engagement with and retention by the legs of the swimmer. The buoy is in the form of a pair of spaced apart cylindrical elements having generally circular cross-section. The generally circular cross-section elements are interconnected by a connecting piece, and the entire buoy is of unitary construction, formed either by molding, extrusion, or die cutting. The buoy includes an attachment device for securing the buoy to the swimmer's body or clothing. The buoy contains one or more compartments to accommodate one or more corresponding vessels which can be inserted and removed in and out of the compartments, and which vessels can be selectively filled with material which may be used to vary the buoyancy of the buoy, as well as maintaining a water-tight storage compartment, or utilized as a storage vessel for consumable liquids, such as water or sports drinks. The shape of the buoy accommodates the legs of the swimmer, providing flotation to the hips and legs of the swimmer. Ideally, the foam material is of sufficient resilience to be comfortably carried between the swimmer's legs without causing discomfort or irritation.

By utilizing one or more removable vessels in combination with the buoy, a single sized buoy can provide a wide range of buoyancies to accommodate the needs of an equally wide range of swimmers.

### BRIEF DESCRIPTION OF THE DRAWINGS

FIG. 1 is a perspective view of a buoy embodying the concept of the present invention, showing its placement and orientation in relation to the body of the typical swimmer.

FIG. 2 is a side elevation of the buoy of FIG. 1.

FIG. 3 is a top view of the buoy of FIG. 1.

FIG. 4 is a perspective view of the buoy of FIG. 1 showing the warning device and buoy in relation to the body of the typical swimmer.

### DESCRIPTION OF THE PREFERRED EMBODIMENT

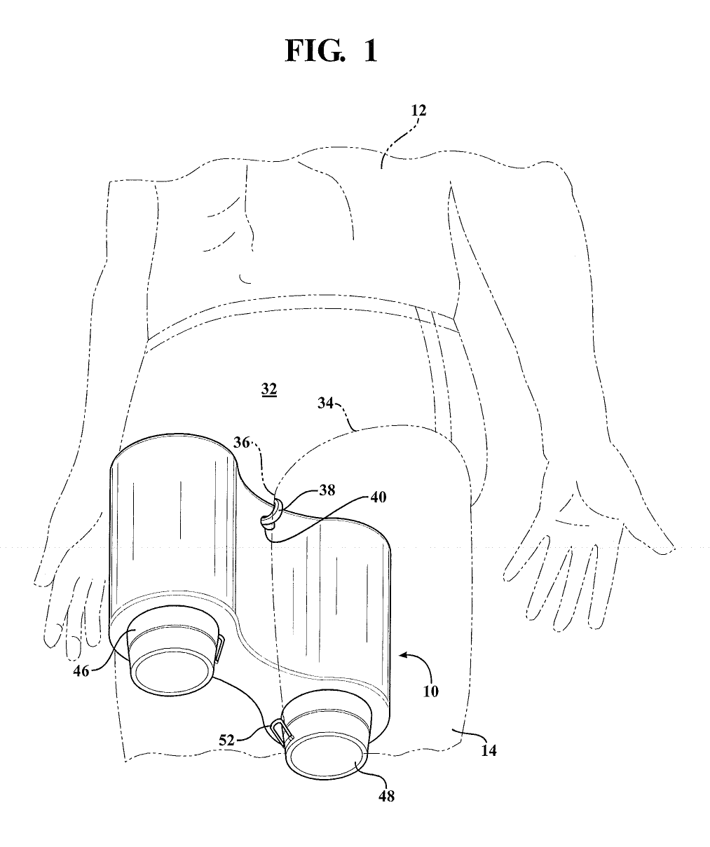

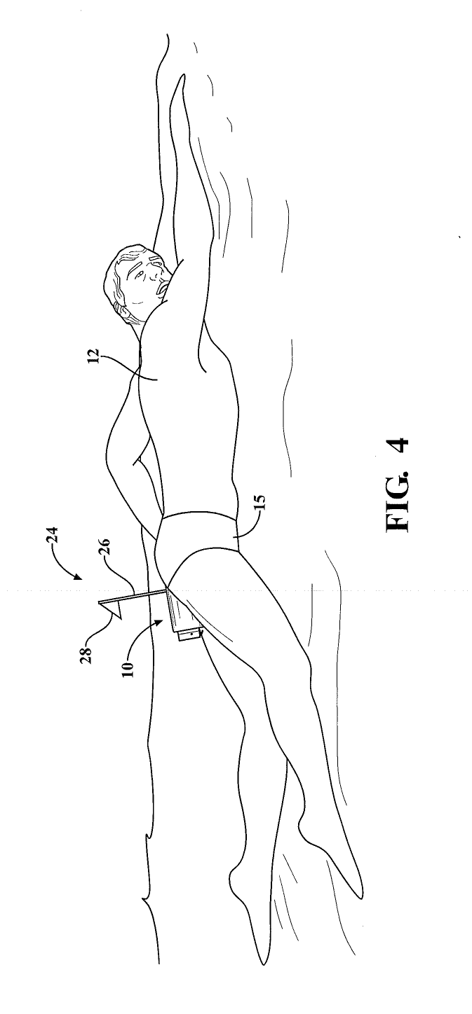

A buoy according to the present invention is generally indicated by the numeral 10 in FIGS. 1 through 4 of the drawings. As shown in the drawings, the buoy is shaped and configured so as to be positioned between the legs 14 of the swimmer 12. Preferably, the buoy is formed as a unitary body from a flexible polyethylene foam or any highly buoyant material, which may be formed by molding, extrusion, die cutting or any other method known to those skilled in the art. Preferably the buoy 10 is formed of a suitable resilient and non-abrasive foam material so as to provide sufficient flotation to the swimmer's legs while at the same time minimizing irritation or discomfort. The buoy 10 is formed so as to have a first cylindrical portion 16 and a second cylindrical portion 18 interconnected by a connecting portion 20, creating a rounded hour glass-shaped cross-section. The connecting portion 20 of the buoy 10 serves to form concave portions 22 which engage the interior aspects of the legs of the swimmer utilizing the device. When positioned by the swimmer, the connecting portion 20 is sandwiched between the legs 14 of the swimmer, with cylindrical portions 16 and 18 extending anterior and posterior to the swimmer's legs 14. This positioning is best depicted in FIG. 1, wherein the body 12 and legs 14 of the swimmer are shown in ghost view in relation to the buoy 10.

Also depicted in FIG. 1 is a removable warning device 24, which extends from the buoy 10 perpendicular to the body 12 of the swimmer. The warning device 24 includes a flag support 26, which extends substantially above the surface of the water for visibility, and a flag 28 on the distal end of the flag support 26. The flag 28 may be made of plastic, wood, fiberglass, canvas, cotton, nylon, or any other suitable material for exposure to moisture and sun. Preferably, the flag 28 is attached to the flag support 26 by adhesive, but the flag may also be attached by mechanical fasteners. Further, the flag support 26 may be made of plastic, wood, fiberglass, or any other suitable material for exposure to moisture and sun. Preferably the flag support 26 is inserted into a flag pole cavity 30 located on either the first cylindrical portion 16 or second cylindrical portion 18. However, those skilled in the art will understand that the flag support cavity 30 may be placed elsewhere on the buoy 10. Although the shapes of the flag pole 26 and flag support cavity 30 are cylindrical in the preferred embodiment, any cross-sectional shape may be incorporated, such as rectangular, triangular, or any other polyhedron.

Further as depicted in FIG. 1, swimmers generally, while training, wear layered clothing including swimming trunks 32 having leg openings 34 and a crotch element 36 positioned between the leg openings 34. To secure the buoy 10 to the swimmer 12, in the preferred embodiment a fastener 38 engages a through-hole 40 in the buoy 10. Fastener 38 then loops around the crotch 36 of swimming trunks 32. Fastener 38 may be a strap, a string, a buckle, a ring, a hook and loop-type fastener, a clip, or any other suitable removable fastener configured to allow the buoy 10 to be secured and/or separated from swimming trunks 32. The through-hole 40 extends through the connecting portion 20 at a point approximately midway between the opposing ends of the buoy as shown in FIG. 3.

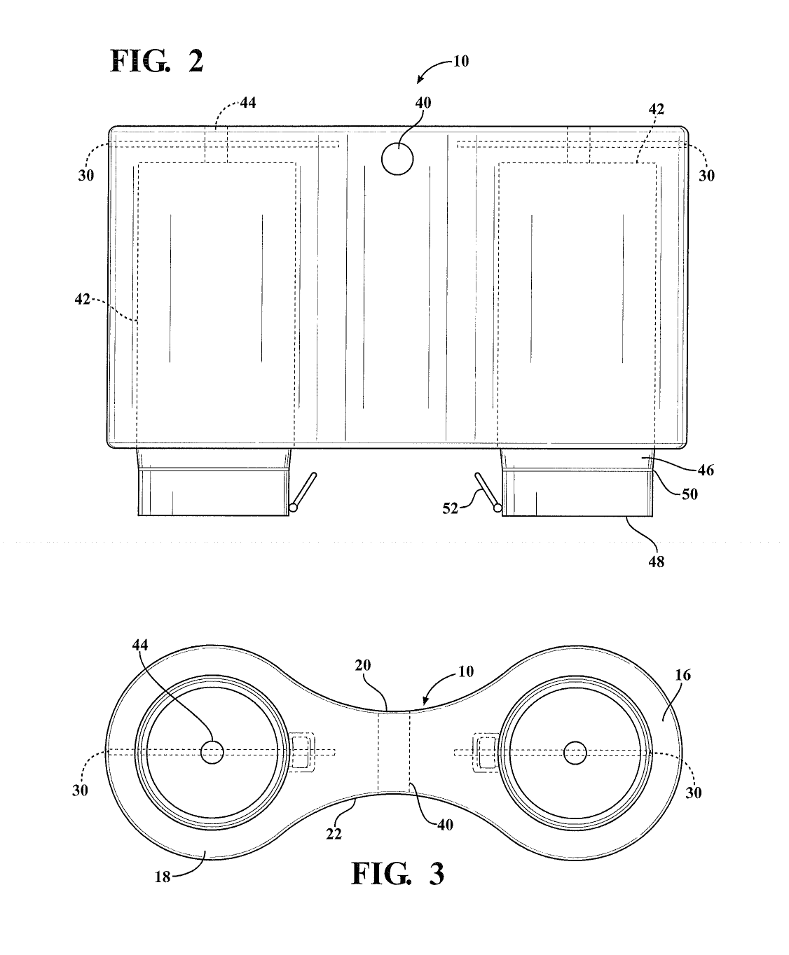

With reference now to FIG. 2, it will be appreciated that buoy 10 is provided with at least one cavity 42. Although in the preferred embodiment the cavity is cylindrical, any cross-sectional shape may be incorporated, such as squares, rectangles, triangles or any other polyhedron. Each cavity 42 is provided with a relief opening 44 to allow air to escape from and enter into the cavity 42 when a removable vessel 46 is inserted into or removed from the cavity 42. Vessel 46 is preferably a resealable vessel of a size appropriate to create a friction fit between the exterior walls of vessel 46 and the interior walls of cavity 42. In this fashion, vessel 46 may be securely held in position within cavity 42, while at the same time being selectively removable from cavity 42 by extraction of the vessel 46 from the cavity. Preferably, vessel 46 is provided with a resealable cap 48 which is sealably affixed to vessel 46 with the incorporation of a flexible seal 50. Typically, vessel cap 48 is threadably attached to vessel 46, but other methods of attachment, such as press fits or bayonet fits may also be incorporated. In the preferred embodiment, a fastening ring 52 may be provided on vessel cap 48, to allow vessel cap 48 to be secured to the buoy 10, or to carry a flexible strap to facilitate carrying of the vessel 46, or insertion or removal of the vessel 46 from the buoy 10.

In use, the buoy is employed by swimmers by positioning the buoy in between the legs of the swimmer 12, and is secured to the swimmer's body or clothing by a fastener 38 which can be attached to clothing 32, or to the swimmer's body 12 utilizing other attachment means, such as a belt or strap. The swimmer's legs 14 engage the outer surface of the buoy, and hold the buoy 10 in position between the swimmer's legs 14, so that the first cylindrical portion 16 is anterior to the swimmer's body and the second cylindrical portion 18 is posterior to the swimmer's body. Because of the hour glass cross-sectional shape of the buoy 10, the buoy 10 is restricted from movement upwardly or downwardly in relation to the swimmer's legs 14, thereby providing a comfortable yet secure positioning of the buoy between the swimmer's legs 14.

The amount of buoyancy created by the buoy 10 is dependent on the buoyancy of the foam material constituting the first cylindrical portion 16, second cylindrical portion 18 and connecting portion 20, together with the buoyancy of the contents of the vessels 46. For maximum buoyancy, vessels 46 contain only air at atmospheric pressure and provide buoyancy corresponding to the weight of the water displaced by the empty vessel 46.

At the other end of the buoyancy spectrum, vessels 46 may be filled with a heavy dense material, such as iron or stone, which will result in a completed assembly of buoy 10 and vessels 46 providing only negative buoyancy. Alternatively, vessels 46 can be replaced with fixed weights (not shown) of a physical configuration complimentary in shape and dimension to the interior shape and dimension of cavity 42.

Between these two extremes, vessels 46 may be completely or partially filled with fluid, such as water which provide greater amount of buoyancy than that accomplished by the use of weights, but a lesser amount of buoyancy accomplished by the use of empty vessels 46 alone. Accordingly, it will be appreciated that by selection of the weights, vessels and contents utilized with the buoy 10, the amount of buoyancy available to the swimmer 12 can be precisely adjusted.

It will also be appreciated that vessels 46 may be utilized as a container for refreshments, such as potable water or other beverage, or personal belongings like identification cards, wallets, spectacles, and cell phones.

In another embodiment, cavities 42 will be formed of a complimentary size to a standard drink container, such as an aluminum soft drink can.

Further, when the swimmer chooses to use the removable warning device 24, the swimmer inserts the flag pole 26 into the flag pole cavity 30.

It will be appreciated then that the above-described invention provides a swimmer's training and coach's teaching aid which provides a selectable, variable degree of buoyancy, while at the same time providing means for securing the training aid to the body of the swimmer, and provides storage for weights, variable ballast, refreshments or personal items, and provides a single component which can be customizable for use by swimmers of different sizes and density.

Having thus described my invention, it will be apparent to those skilled in the art that numerous modifications and variations may be made of the inventive concept of the invention, without departing from the invention herein claimed.

What is claimed is:

1. In a buoy for supplementing the buoyance of a swimmer's legs and hips comprising a unitary foam member adapted for engagement with and selective retention by the legs of the swimmer, the improvement comprising at least one cavity formed in said buoy adapted to engage at least one vessel, whereby said vessel may be selectively filled with ballast.

2. The invention of claim 1, which further comprises a fastener for interconnecting said buoy with a garment worn by the user.

3. The invention of claim 2, wherein said fastener comprises a fabric loop.

4. The invention of claim 2, wherein said fastener comprises a hook and loop fastener.

5. The invention of claim 2, wherein said fastener comprises a snap hook.

6. The invention of claim 2, wherein said fastener comprises a strap.

7. In a buoy for supplementing the buoyancy of swimmers' legs and hips comprising unitary foam member adaptive for engagement with and selective retention by the legs of the swimmer, the improvement comprising at least one cavity formed in said buoy adapted to engage at least one removable weight.

8. The invention of claim 1, wherein said at least one cavity is sized to accommodate a vessel of the size of a commercially available beverage container.

9. The invention of claim 1, which further comprises a warning device removably attached to the training buoy for alerting nearby watercraft of a swimmer.

10. The invention of claim 9, wherein said warning device comprises a flag and flag support.
